(19) United States
(12) Patent Application Publication
(10) Pub. No.: US 2018/0096430 A1
(43) Pub. Date: Apr. 5, 2018

(54) ABS Asset Backed Security Structure System

(71) Applicant: Michael Jacob Cohen, Tucson, AZ (US)

(72) Inventor: Michael Jacob Cohen, Tucson, AZ (US)

(21) Appl. No.: 15/286,325

(22) Filed: Oct. 5, 2016

(51) Int. Cl. G06Q 40/06; G06Q 40/02

(52) U.S. Cl. CPC G06Q 40/06; G06Q 40/02

(57) ABSTRACT

A manager/coordinator 200 facilitates a specially directed creation and distribution of financial instruments such as Ginnie Mae certificates 830 with the financial instruments disposed in a dual trustee system that may comprise a trustee 700 and co-trustee 750. Dividends or other payments from the Ginnie Mae certificates may be sent by the trustee directly to an investor 500. Disclosed embodiments allow a Ginnie Mae Issuer/Servicer 300 to create and distribute Ginny Mae certificates for the direct benefit on non-institutional investors and for the benefit of pension plans, with such pension plans devoid of third party thefts.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to systems of creation and distribution of securities and methods of direct monetary payments. More particularly, the invention relates to the construction and use of systems to distribute securities before or after such securities are created and secure systems of direct payments to investors.

### (2) Description of the Related Art

In the related art, adulterated or infused Ginnie Mae securities are known in the art and are not pure Ginnie Mae instruments. As the prior art lacked means or methods of wide spread or fair market distribution of Ginnie Mae instruments, for the average investor, the prior art could merely add Ginnie Mae instruments into mutual funds or other mixed security instruments. The advantages of Ginnie Mae instruments are well known in the art, and such adulterated instruments have been popular purchases for retirement plans. In pension or 401K accounts or similar retirement instruments, employers would control the purchase and sale of the retirement instruments and were capable of wrongfully converting retirement funds to general corporate funds, leaving the pension holders or employees without retirement funds. Thus, there are serious shortfalls in the prior art of financial structures and financial instruments. To a lesser degree, IRAs and similar accounts have faced similar shortfalls.

### BRIEF SUMMARY OF THE INVENTION

The present invention overcomes shortfalls in the related art by presenting an unobvious and unique combination, configuration and use of computer structures, financial structures and financial instruments to overcome shortfalls in the art wherein such shortfalls included the pilfering of pension funds. Moreover, the disclosed embodiments overcome shortfalls in the prior art wherein only a few select institutions could obtain pure Government National Mortgage Association securities, (hereinafter sometimes referred to as “Ginnie Mae” or “GNMA” securities).

The disclosed embodiments overcome shortfalls in the prior art in many aspects, including the use of systems to pre-purchase pure Ginnie Mae securities by a pre-acquisition process involving a Ginnie Mae Issuer/Servicer. In general, a relatively few number of institutions are approved to upload bundles of mortgages in exchange for Ginnie Mae certificates or related instruments. Once acquired, using the disclosed systems, the pure Ginnie Mae certificates are held by system trustees who distribute dividends or payments directly to investors. While the end products of the disclosed systems are straight forward and result in pure Ginnie Mae securities benefiting individual investors and while the disclosed systems vitiate the need for traditional pension systems controlled by employers or unions, the mechanics and structures of the disclosed systems are far from obvious.

Disclosed systems may start with a disclosed escrow process and may be executed or viewed in various forms and chronologies, the following descriptions are included embodiments.

A manager or coordinator may secure the services of one more financial advisors to find qualified investors. The qualified investors may communicate directly with a financial advisor so as to prequalify for qualified investor status and to allow a financial advisor to perform all of the needed administrative tasks. A financial advisor may also collect funds from a qualified investor and direct such funds to the initial escrow process. The direct interaction of qualified investors with financial advisors has the advantage of insulating the manager/coordinator from direct involvement with the public and private investors and streamlines the tasks of the manager/coordinator.

Disclosed embodiments include the use of a co-trustee, being an institution of acceptable financial integrity, working in concert with one or more financial advisors, to secure funds to be held in an escrow account. Or, the co-trustee may have a more limited role in overseeing the activities of the trustee.

Once qualified investor funds are secured in an escrow account, a primary dealer or Ginnie Mae issuer/servicer may make ready to upload mortgages and other financial instruments in order to obtain Ginnie Mae instruments or certificates. After upload, the resulting Ginnie Mae instruments may be deposited in escrow. Once the Ginnie Mae instruments are in escrow along with the qualified investor funds, the Ginnie Mae instruments may be deposited with the trustee and the qualified investor funds will be released by the seller in exchange for the Ginnie Mae securities.

After a close of escrow, a trustee or holding entity, of acceptable financial integrity, will hold the Ginnie Mae instruments and distribute payments directly to the investors. While the co-trustee will supervise and audit the actions of the trustee, both the co-trustee and trustee may be part of the initial escrow process or a separate entity may act as the escrow agent.

After the close of escrow, the Ginnie Mae instruments or certificates will generate income in a traditional and predictable fashion. Such income is initially directed to the holding trustee, and as mentioned above, the trustee directs payments directly to the qualified investors or the designated recipients of the qualified investors. The use of the trustee and co-trustee ensures that the Ginnie Mae payments are properly distributed and overcomes shortfalls in the art as qualified investors may be part owners of a single Ginnie Mae instrument.

With the use of the disclosed systems, ongoing retirement fund investments may be placed in periodically occurring escrows wherein the retirement funds result in the acquisition of additional Ginnie Mae instruments. The resulting Ginnie Mae payments may be directed by the trustee with the supervision of the independent co-trustee, thus employers and unions are not able to abscond with retirement funds.

The disclosed embodiments overcome shortfalls in the art by providing smaller investors access to Ginnie Mae securities which are a product of GNMA which is wholly owned and supported by the United States Government. Unlike other financial instruments, the underlying mortgages uploaded to the United States Government in exchange for the Ginnie Mae securities do not influence the rates of return for the Ginnie Mae securities. The Ginnie Mae securities pay dividends that are not tied to the performance of the exchanged mortgages. Thus, Ginnie Mae securities have been highly sought after and in the prior art, not available to the general public.

The disclosed manager/coordinator overcomes short falls in the related art by facilitating the more equitable distribution of pure Ginnie Mae securities. The disclosed manager/coordinator may receive a fee upon every close of escrow and may receive percentages of subsequent payments to qualified investors.

The disclosed embodiments may be manifested in physical embodiments in the form of general purpose or special purpose computers and/or network systems used to coordinate the flow of funds, securities and interactions as described herein.

### BRIEF DESCRIPTION OF THE DRAWINGS

FIG. 1 is a schematic view of a disclosed embodiment

FIG. 2 is a schematic view of a disclosed system

### REFERENCE NUMERALS IN THE DRAWINGS

100 a disclosed embodiment in general

200 manager/coordinator

300 Ginnie Mae Issuer/Servicer

400 United States Government

500 investor or qualified investor

600 financial advisor

700 trustee or primary trustee

750 co-trustee

800 hardware system in general

810 machine readable instruction

815 non-volatile memory

820 general or specialized processor

825 specialized or general computer

830 Ginnie Mae certificate or instrument

840 Ginnie Mae Issuer/Servicer database system

842 investor database system

844 financial advisor database system

846 co-trustee database system

848 trustee database system

850 manager/coordinator database system

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

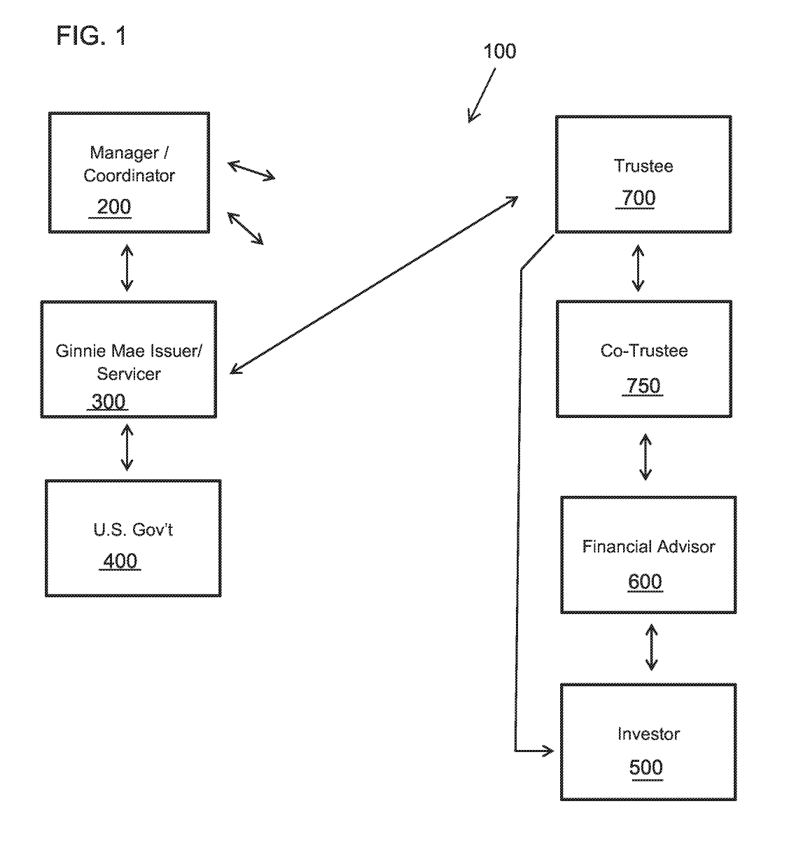

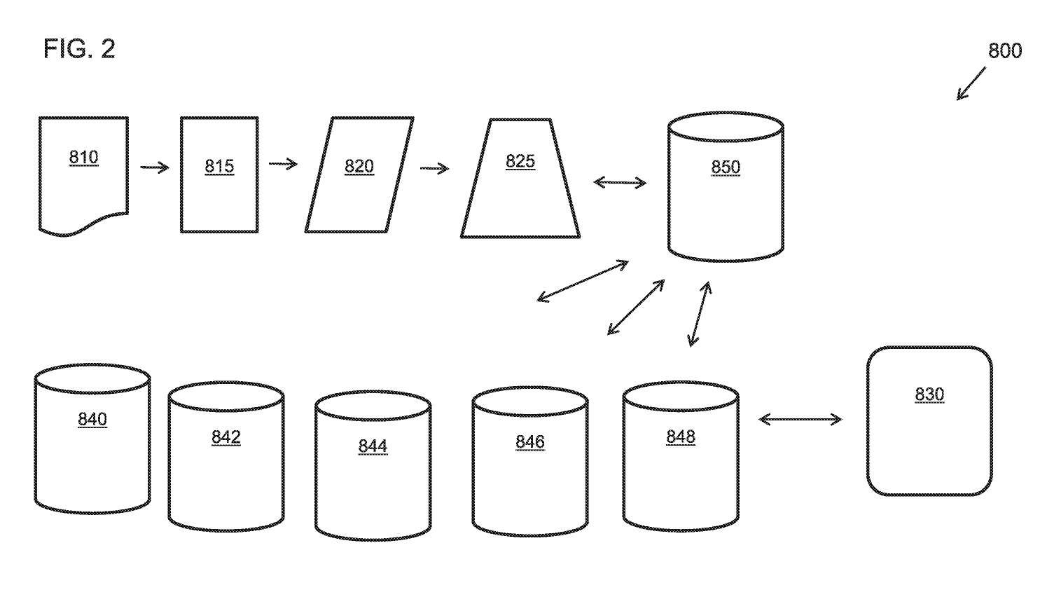

Referring to FIG. 1, a disclosed embodiment 100 may include the use of a general computer or specialized computer, the specialized computer may have a specialized processor and/or a specialized database system, as reflected in FIG. 2.

In a disclosed embodiment 100 a manager/coordinator 200 may be in electronic communication with a Ginnie Mae Issuer/Servicer 300, with the Issuer/Servicer 300 capable of exchanging mortgages or loan instruments for Ginnie Mae securities (830, FIG. 2) or similar instruments by use of machinery to upload such mortgages or loan documents to the United States Government 400 with such uploading sometimes executed by use of specialized machine readable instructions and/or specialized high security hardware.

A manager/coordinator 200 may be in electronic communication with one or more financial advisors 600. In a disclosed embodiment a lead financial advisor may coordinate with a plurality of lower level financial advisors. Financial advisors 600 may be in electronic communication with one or more investors 500. In a disclosed embodiment, investors 500 may include qualified investors to comport with the overall regulatory scheme of the overall transactions.

Investment funds may be placed into an escrow account, or a series of escrow accounts for ongoing investments. Such investment funds may originate from investors 500 and be collected by financial advisors 600. Such investment funds may be placed into an escrow account by financial advisors, investors 500 or other entities. Prior to or after a Ginnie Mae Issuer/Servicer 300 obtains Ginnie Mae instruments, purchase orders or other arrangements may be made by a manager/coordinator 200. Investor funds may be placed into an escrow account and Ginnie Mae instruments may also be placed into an escrow account. Once both the investor funds and Ginnie Mae instruments are in the escrow account or escrow accounts, the funds may be paid to the Issuer/Servicer and the Ginnie Mae instruments may be transferred to a trustee 700. A third party may act as the escrow agent or a trustee 700 or co-trustee may act as an escrow agent.

As Ginnie Mae instrument dividends or payments are made by the U.S. Government 400, the funds may be sent by book entry or other means to the trustee 700. The trustee in turn may directly transfer funds to the investors 500. A co-trustee may 750 supervise and monitor the transactions and activity of the trustee 700.

Referring to FIG. 2, a hardware system 800 in general is shown and may comprise machine readable instructions 810 stored upon non-volatile memory 815, with the non-volatile memory suppling instructions or commands to a processor 820 with the processor being a general processor or a specialized computer processor, the processor part of a server 825 or computer, the computer or server being a general computer or a specialized computer, with the computer in communication, over an electronic network, with a plurality of database systems. The database systems may include a manager/coordinator database or computer system 850 in communication with the server 825 and in commutation with various database or computer systems such as a Ginnie Mae Issuer/Servicer database system 840, investor database system 842, financial advisor database system 844, co-trustee database system 846, and trustee database system 848. The trustee database system 848 may store and/or control one or more Ginnie Mae certificates or instruments 830 and may cause Ginnie Mae payments to be made to investors. Ginnie Mae payments may take the form of dividends which may be comprised of principal and interest payments.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A computer, server and database system (800) implemented method (100) of funding, creating and distributing financial instruments, the method comprising:
a) the use of the computer, server and database system, the computer, server and database system comprising: machine readable instructions (810) stored upon non-volatile memory (815) with the non-volatile memory executed by a processor (820) the processor in interaction with a computer (825), the computer used as a server when in communication with a manager/coordinator database system (850), the manager/coordinator database system in communication with a plurality of database systems, the plurality of database systems comprising a Ginnie Mae issuer/servicer database system (840), an investor database system (842), a financial advisor database system (844), a co-trustee database system (846), a trustee database system (848);
b) the computer, server and database system used to direct funds from investors (500) to financial advisors (600), to escrow;
c) the computer, server and database system used to direct a Ginnie Mae issuer/servicer (300) to upload mortgage instruments in exchange for Ginnie Mae securities (830) and to direct the Ginnie Mae securities to escrow;
d) the computer, server and database system used to direct the Ginnie Mae securities to a trustee (700);
e) the computer, server and database system used to direct dividends from the Ginnie Mae securities from the trustee to the investors.

2. The method of claim 1 wherein the co-trustee database system is used to monitor the trustee with the trustee's distribution of dividends to the investors.

3. The method of claim 2 wherein the Ginnie Mae issuer/servicer database system is used to direct the Ginnie Mae securities to the trustee by use of the trustee database system.

4. The method of claim 3 wherein the manager/coordinator database system directs a commission to the manager/coordinator, the commission paid out of the escrow.

5. The method of claim 4 wherein the manager/coordinator database system directs the Ginnie Mae issuer/servicer database system to direct the Ginnie Mae issuer servicer to perform upload of mortgage instruments in exchange for the Ginnie Mae securities.

6. The method of claim 5 wherein the trustee database system directs the trustee in the trustee's direction of dividends to the investors.

7. The method of claim 1 wherein the computer, server and databased system is used to direct dividends from the Ginnie Mae securities to investors, wherein the investors comprise 401(k) plans, pension plans and retirement plans.
